(19) United States
(12) Patent Application Publication
(10) Pub. No.: US 2005/0197192 A1
(43) Pub. Date: Sep. 8, 2005

(54) Drive-transmission device

(75) Inventor: Hiromichi Komai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HITACHI LTD.

(21) Appl. No.: 11/070,250

(22) Filed: Mar. 3, 2005

(30) Foreign Application Priority Data
Mar. 4, 2004 (JP) 2004-59974

(51) Int. Cl. F16H 47/04

(52) U.S. Cl. 464/146

(57) ABSTRACT

A drive-transmission device includes an absorbing mechanism. The absorbing mechanism having a drive shaft, a driven shaft, a tubular intermediate shaft, a first joint and a second joint. The drive shaft is connected with a first end portion of the tubular intermediate shaft through the first joint, and the driven shaft is connected with a second end portion of the tubular intermediate shaft through the second joint. The absorbing mechanism absorbs an axial load by permitting at least one of the drive and the driven shaft to slide into the tubular intermediate shaft through the each joint.

### BACKGROUND OF THE INVENTION

The present invention relates to a drive-transmission device or transmission shaft for motor vehicles, and more particularly, to the shock-absorbing mechanism for absorbing an input load acting axially on the transmission shaft.

A typical drive-transmission device is disclosed in JP-A-10-338046.

This drive-transmission device is applied to a transmission shaft for motor vehicles, wherein a transmission shaft comprises a drive shaft on a transmission side and a driven shaft on a final drive side. The drive shaft and the driven shaft each comprise an end portion that is connected with slidable constant velocity joints. A narrow small diameter connecting shaft is disposed between the joints. The torque of the drive shaft is transmitted to the driven shaft through the joints and the connecting shaft.

Each joint comprises a shock absorbing mechanism for absorbing a force or shock when a relative axial movement of the drive shaft and/or the driven shaft occurs with respect to the connecting shaft.

An input load acting axially on the transmission shaft is absorbed by the relative axial movement of the shaft and the operation of the shock absorbing mechanism.

The relative movement occurs with respect to the connecting shaft. Therefore, the length of the connecting shaft needs to be sufficient long.

There is a natural frequency of the transmission shaft during rotation, which normally is low. Because of the connecting shaft is long, vibration of the transmission shaft occurs between a normal rotation speed and a high rotation speed. Vibration of the transmission shaft generate noise, which is undesirable.

### SUMMARY OF THE INVENTION

It is an object of present invention to provide a drive-transmission device for a motor vehicle. The drive-transmission device comprises; a drive shaft; a driven shaft; a tubular intermediate shaft; a first joint and a second joint. The drive shaft is connected with a first end portion of the tubular intermediate shaft through the first joint. The driven shaft is connected with a second end portion of the tubular intermediate shaft through the second joint. An absorbing mechanism is provided for absorbing an axial load by permitting at least one of the drive and the driven shaft to slide into the tubular intermediate shaft through each joint.

According to other aspect of the present invention, there is provided a drive-transmission device apply for a propeller shaft for vehicle comprises; a drive shaft; a driven shaft; a tubular intermediate shaft; a first joint; a second joint. The drive shaft is connected with a first end portion of the tubular intermediate shaft through the first joint; the driven shaft is connected with a second end portion of the tubular intermediate shaft through the second joint. And an inner diameter of the tubular intermediate shaft is larger than a diameter of the drive shaft and driven shaft.

### BRIEF DESCRIPTION OF THE DRAWINGS

FIG. 1 shows a longitudinal cross section of a transmission shaft according to an embodiment of the present invention;

FIG. 2 shows a longitudinal cross section of the transmission shaft in a vehicular collision;

FIG. 3 shows a longitudinal cross section of the transmission shaft in a vehicular collision greater than FIG. 2;

FIG. 4 shows a longitudinal cross section of the transmission shaft in a vehicular collision greater than FIG. 3;

FIG. 5 shows a the longitudinal cross section of the transmission shaft in a vehicular collision greater than FIG. 4;

FIG. 6 shows a longitudinal cross section of the transmission shaft in a vehicular collision greater than FIG. 5;

FIG. 7 shows a longitudinal cross section of the transmission shaft in a vehicular collision when there is a bending force;

FIG. 8 shows a second embodiment of the present invention.

### DETAILED DESCRIPTION OF THE INVENTION

Referring to the drawings, a description is made of an absorbing mechanism for a power transmission device for motor vehicles embodying the present invention. In the illustrative embodiment, the power transmission device includes a transmission shaft.

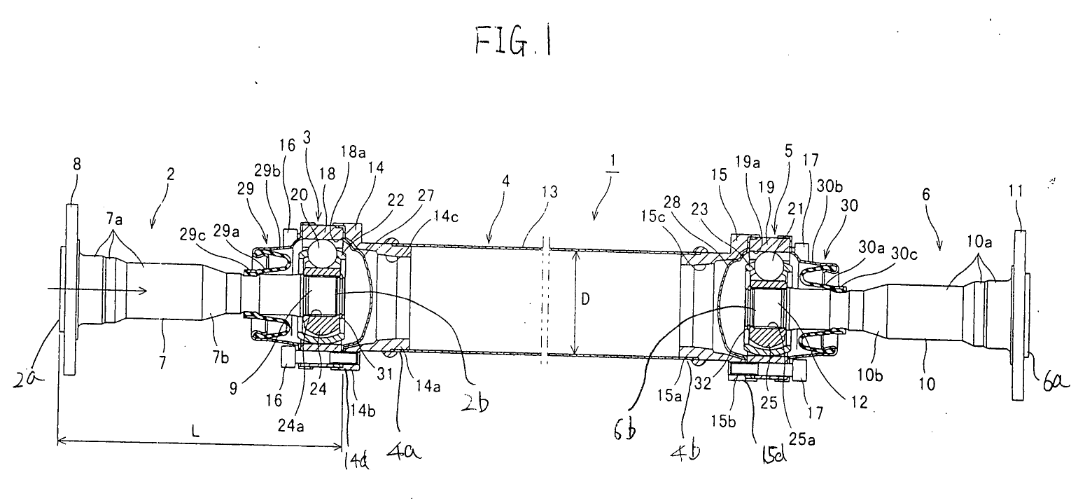

As is seen in FIG. 1, a transmission shaft 1 comprises a drive shaft 2, a driven shaft 6, a tubular intermediate shaft 4, a first joint 3, and a second joint 5. The drive shaft 2 is connected with a first end portion of the tubular intermediate shaft 4a through the first joint 3. The driven shaft 6 is connected with a second end portion of the tubular intermediate shaft 4b through the second joint 6.

The drive shaft 2 comprises a shaft portion 7 having a diameter that varies in a generally step-like manner. The drive shaft 2 also has a flange portion 8 disposed at a first end portion of the drive shaft 2a for coupling with a transmission, and a stub shaft 9 disposed at a first end portion of the drive shaft 2a for coupling with the first joint 3. A length of the drive shaft 2 is relatively short, as compared to the intermediate shaft 4.

The shaft portion 7 has a different diameter portion between the second end portion 2b and the flange potion 8. A diameter of first end portion of the drive shaft 2b is larger than diameter of first end portion of the drive shaft 2a. The drive shaft 2 has a conical portion 7b between the different diameter portions.

The driven shaft 6 comprises a shaft portion 10 having a diameter that varies in a generally step-like manner. The driven shaft also has a flange portion 11 disposed at a first end portion of the shaft 6a for coupling with a transmission, and a stub shaft 12 disposed at a first end portion of the driven shaft 6a coupling with the second joint 5. A length of the drive shaft 6 is relatively short, compared to the intermediate shaft 4.

The shaft portion 10 has a different diameter portion between the second end portion 6b and the flange portion 11. The diameter of first end portion of the drive shaft 6b is larger than diameter of first end portion of drive shaft 6a. The driven shaft 10 has a conical portion 10b between the different diameter portions.

The tubular intermediate shaft 4 comprises a tube 13 that extends between a front side and a rear side of the vehicle, and a connector 14, 15 at each end. Each connector 14, 15 is connected at a respective portion of the tube 13 by welding.

The tube 13 is made of a metal and has a relatively long length as compared to the drive and the driven shafts. The tube 13 has an inner diameter D that is smaller than an outer diameter of each of the joints 3, 5.

Each of connectors 14, 15 have substantially same design. Each connector 14, 15 comprise a stepped inner diameter portion, a base portion 14a, 15a, a tube portion 14b, 15b. The tube portion 14b, 15b is integrated with the tip of base portion 14a, 15a, which has a large diameter as compared with the base portion 14a, 15a.

The base portion 14a, 15a is fitted to each end of the tube 13 such that a inner surface of base portion 14c, 15c have a different inner diameter portions, inner diameter of a tubular intermediate portion side is smaller than the inner diameter of an outer race side.

The thickness of the tube portion 14b, 15b is thicker than that of the base portion 14a, 15a. A inner surface of each connector 14, 15 has a curved receive portion for receiving a torque transmission ball 20, 21 when at least one of the drive shaft 2 and the driven shaft 6 slides into the tube 13 and has a flange 14d, 15d that is formed on a outer surface. Flange 14d, 15d has several screw holes along a circumference.

The first joint 3 and the second joint 5 are formed with substantially the same design. Each is a constant velocity joint, for example a so-called cross-groove joint. As shown in FIG. 1, such constant velocity joint comprises an annular outer race 18, 19, an outward-spherical-ring-shaped cage 22, 23, and an inner race 24, 25. The outer race 18, 19 is axially fitted in the flange of the tube portion 14b, 15b of the connector 14, 15 by bolts 16, 17. The cage 22, 23 is disposed on the inside of the outer race 18, 19 for holding balls 20, 21. Balls 20, 21 are located on a division into an equal plane. The plane is made by location of half of a bended angle of the inner race 24, 25 and outer race 18, 19. The inner race 24, 25 is supported so that balls 20, 21 can be rotatably held on the inner race 24, 25.

The outer race 18, 19 has a plurality of groove 18a, 19a for holding balls 20, 21. A metal grease cap 27, 28 is attached on the end of the outer race 18, 19 for holding grease inside of the outer race 18, 19. The groove 18, 19 has an angle of inclination to the longitudinal axis. Moreover, holes for holding bolts 16, 17 are formed at a predetermined circumference portion of the outer race 18, 19. The holes are formed to pass through the outer race 18, 19 in an axial direction.

The grease cap 27, 28 has a center portion that is formed in a spherical-ring-shape toward the tubular intermediate shaft 4 and has a ring-shaped outer portion that is fitted to end portion of inner surface of the outer race 18, 19.

Each inner race 24, 25 has a respective inner spline hole 24a, 25a on the center for connecting with a end of the stub shaft 9, 12 and has a plurality of grooves for holding balls 20, 21. The grooves are formed in a spherical-ring-shaped outer surface of the inner race 24, 25. The inner surface of the groove has an angle of inclination cross groove 18, 19. Balls 20, 21 are disposed in the grooves of the inner race 24, 25 and the grooves of outer race 18, 19 for transmitting a torque between the races. Moreover, each inner race 24, 25 is designed to be removable from the stub shaft 9, 12 by a snap ring 31, 32, which is fixed on a tip of the stub shaft 9, 12.

The first joint 3 and the second joint 5 hold balls 20, 21 for transmitting a torque between cross point of the grooves. Normally, an axial relative travel amount of the outer race 18, 19 and the inner race 24, 25 is regulated by the cage 22, 23 and the inner race 24, 25.

A seal boot 29, 30 is disposed between the outer race 18, 19 and the drive shaft 2 and the driven shaft 6. The seal boot 29, 30 and the grease cap 27, 28 is used to prevent entry of dirt and water into the outer race 18, 19.

Each seal boot 29, 30 has a same construction. Each seal boot 29, 30 comprises a rubber boot portion 29a, 30a that has a small diameter potion, a metal retainer 29b, 30b that has a first end portion and a second end portion, a crimp 29c, 30c. The small diameter portion is fixed to outer circumference of the stub shaft 9, 12 by the crimp 29c, 30c. A first end portion of a retainer is fixed to outer circumference of the rubber boot portion 29a, 30a. A second end portion of the retainer is fixed the drive and driven shaft side of the outer race by bolts 16, 17.

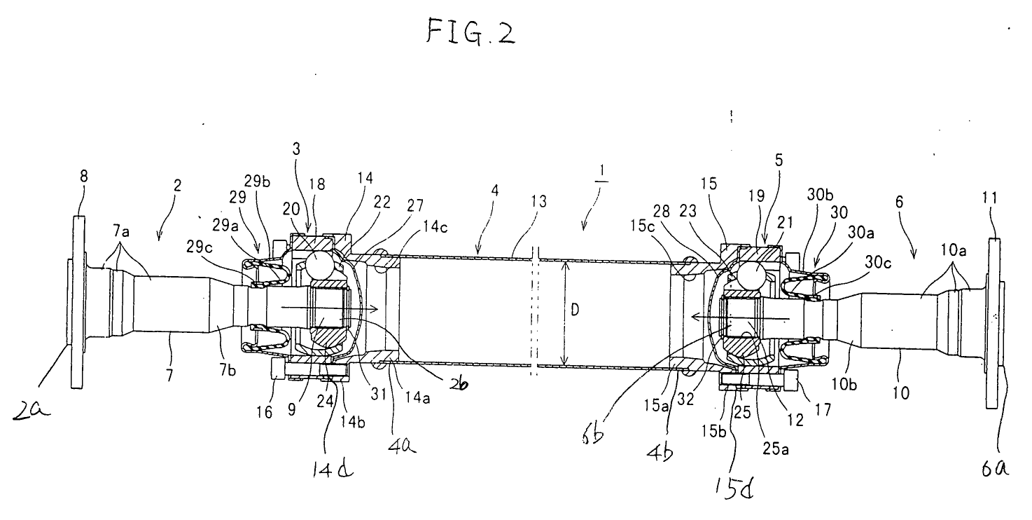

In this embodiment, as shown in FIG. 1, a collision load is input to the drive shaft 2 from the transmission side, in a direction of FIG. 1. As is seen in FIG. 2, the drive shaft 2 and the driven shaft 6 slide into the tubular intermediate shaft 4 for absorbing an axial load.

The inner race 24, 25 slide into the tubular intermediate shaft 4 with the stub shaft 9, 12. When the outer circumference of the inner race contacts the inner circumference of the cage 22, 23 when the inner race slides, the cage is broken into two or three pieces.

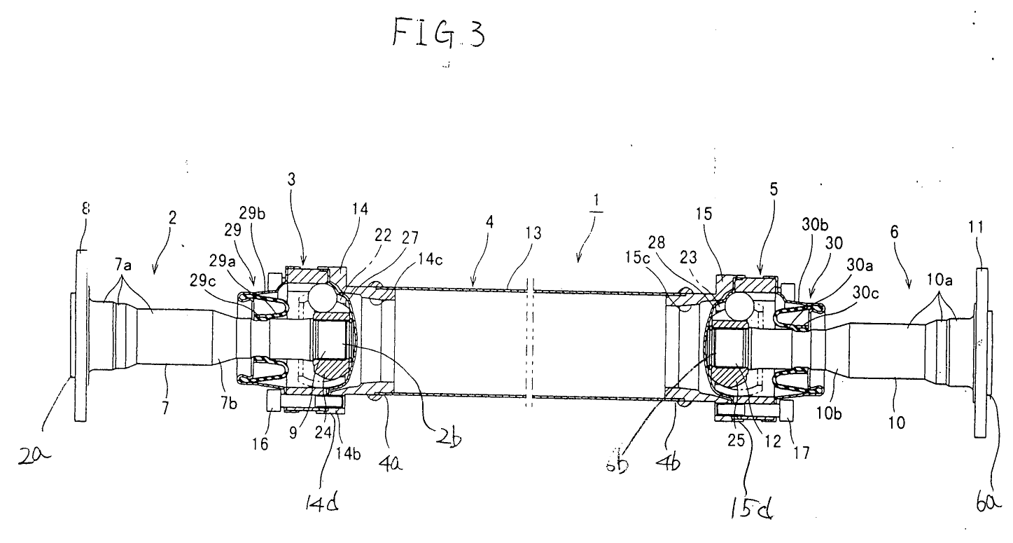

As is seen in FIG. 3, after a cage is broken, the drive shaft 2 and the driven shaft 6 slide to approach the inner race 24, 25. The inner race 24, 25 and the ends of the drive shaft 2 and the driven shaft 6 contact the inside of center of the grease cap 27, 28 and the center of the grease cap 27, 28 is broken.

In this event, balls 20, 21 are released from the cage 22, 23 when it is broken. After that, balls 20, 21 interfere with inside of the outer race 18, 19 and inside of the broken grease cap 27, 28.

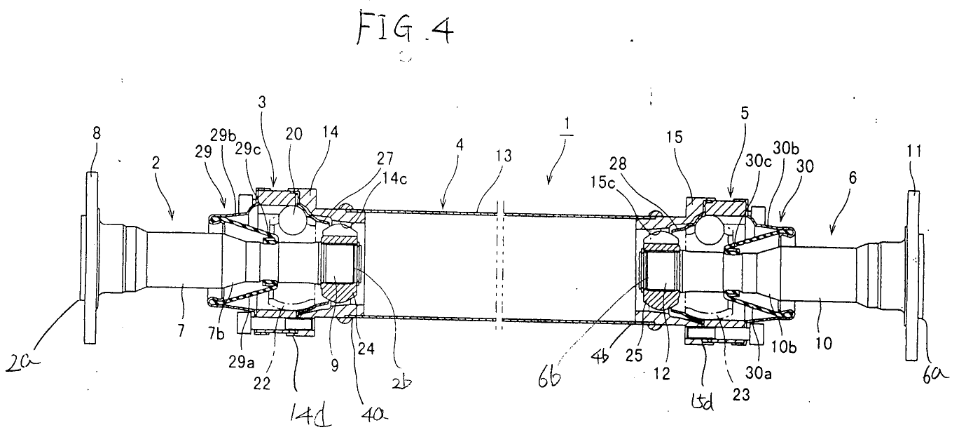

Moreover, as is seen in FIG. 4, the stub shaft 9, 12 and the inner race 24, 25 continuously slide into the tubular intermediate shaft 4 for absorbing the axial load as guided by the inner conical portion of the connector 14c, 15c.

After the grease cap 26, 27 is broken, the drive shaft 2 and the driven shaft 6 axially slide without any obstacle or resistance. Therefore, the drive shaft 2 and the driven shaft 6 slide a great amount, even if a total force is low.

To fix the stub shaft 9, 12 by the boot band 29c, 30c, a small diameter portion of the seal boot 29, 30 is moved with the stub shaft 9, 12, and the rubber boot portion 29a, 30a is pulled into the tubular intermediate shaft 4 from a fixed portion of retainer 29b, 30b.

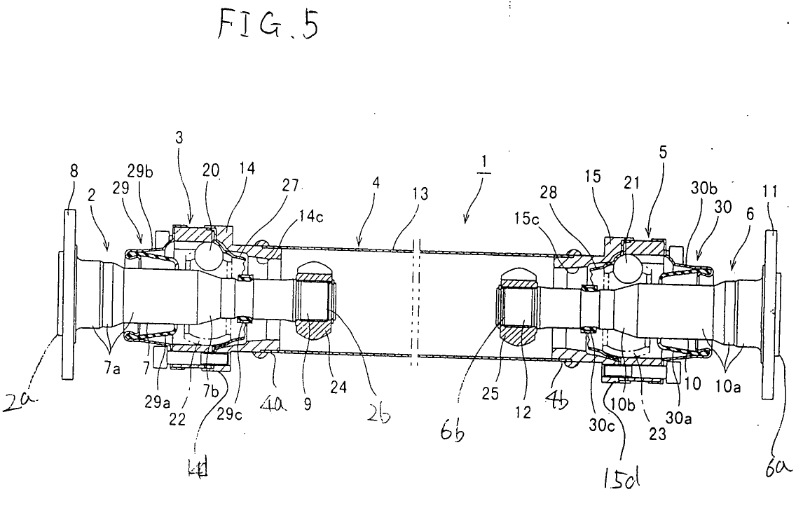

As is seen in FIG. 5, the rubber boot portion 29a is broken, when the drive shaft 2 and the driven shaft 6 slide further.

At this time, the shaft portion 7, 10 does not interfere with balls 20, 21 and the broken the cage 22, 23, when the shaft portion 7, 10 is sliding through the first joint 3 and the second joint 5. This action can absorb axial displacement without interference.

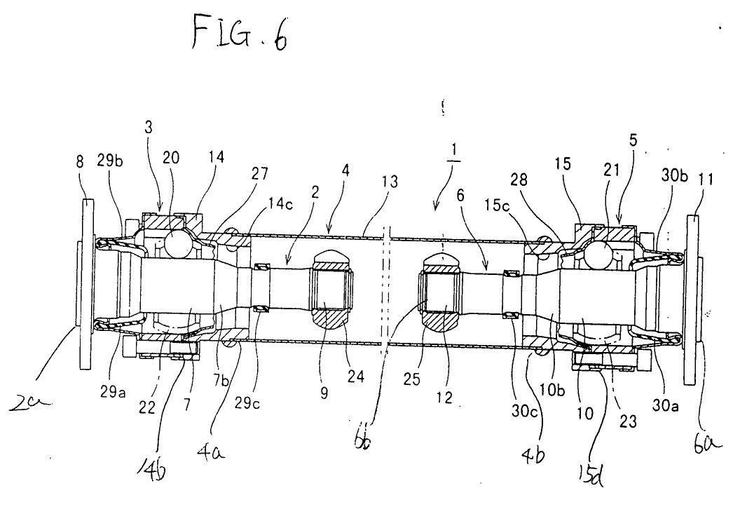

As is seen as FIG. 6, moreover, the drive shaft 2 and the driven shaft 6 slide into the tubular intermediate shaft 4, such that further sliding of the drive shaft 2 and the driven shaft 6 is regulated. Because the inner end of the flange portion 8, 11 of the drive shaft 2 and the driven shaft 6 run into a projected end potion of the retainer 29b, 30b, the axial sliding of the drive shaft 2 and the driven shaft 6 are stopped by this action.

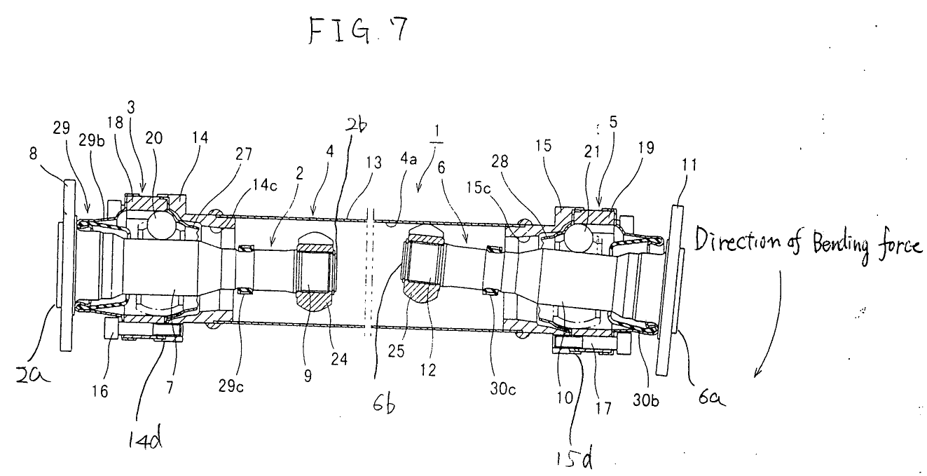

As is seen as FIG. 7, further force may be provided to the drive shaft 2 and the driven shaft 6, for example, the driven shaft 6 may receive a bending force. Then the inner race 25 is moved off center axis by the retainer 30b in the direction of a bending force about a center of the second joint 5, and absorbs the force until contact with the inner surface of the tubular intermediate shaft 4. At this time, any axial load is absorbed further. As a result, the tubular intermediate shaft 4 is prevented from buckling.

Namely, when the tubular intermediate shaft 4 is buckled, it may interfere at the buckled portion with surrounding equipment.

In this embodiment, with the length of the driven shaft 6 sliding out the maximum stroke, the driven shaft 6 and the inner race 25 is moved off center axis by the retainer 30b, which absorbs a bending force. In this way, the tubular intermediate shaft 4 is prevented from buckling and can absorb an axial load.

The drive shaft 2 has a same action as with the driven shaft. When both shafts are moved off center axis at same time, such movement can accomplish more than simply absorbing an axial load by a shaft. In particular, the tubular intermediate shaft 4 is prevented from buckling when absorbing an axial load. Clearly, this is highly effective.

In such a way, in this embodiment, the absorbing mechanism has the drive shaft 2 and the driven shaft 6 slide into first and second end portions of the tubular intermediate shaft 4a, 4b, instead of having a narrow and small diameter connecting shaft used for sliding. Therefore, length of the drive shaft 2 and the driven shaft 6 can be relatively short, as compared to the connecting shaft, and the diameter of shaft portion of the drive shaft 7 and the driven shaft 10 can be large by way of the different diameter portions 7a, 10a.

Accordingly, the natural frequency of the transmission shaft during rotation can be high, Thus, vibration and noise of the transmission shaft can be prevented between a normal rotation speed and a high rotation speed.

Further, in this embodiment, when the drive shaft 2 and the driven shaft 6 are axially sliding, an obstacle and a resistance are prevented by the conical portion 7b, the conical portion 10 and the inner surface of basic portion 14c, 15c. Therefore, a sliding force is controlled to be lower.

As a result, an absorbing mechanism can obtain sufficient absorbing efficacy for absorbing axial displacement with a large sliding amount and a low sliding force.

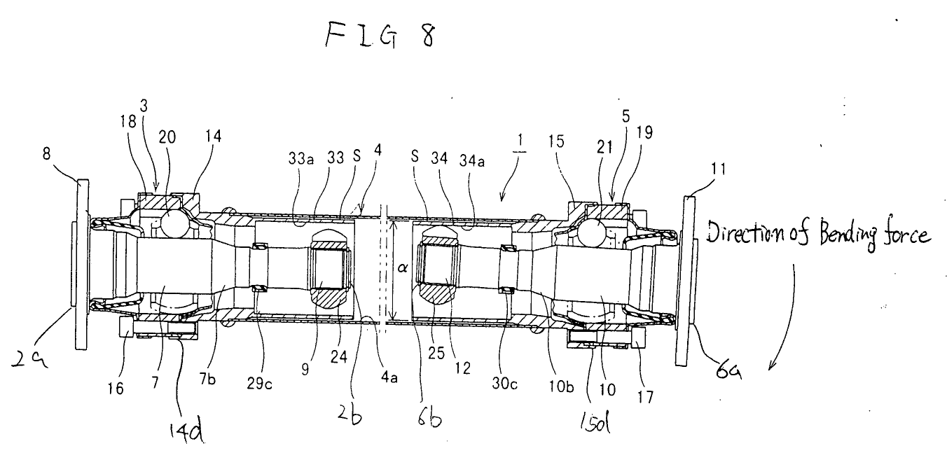

Referring to FIG. 8, there is shown a second embodiment of present invention wherein the connector 14, 15 having a protector 33, 34 which extends along inner surface 4a of the tubular intermediate shaft 4. The protector 33, 34 is integrated with end portions of the base portions of the connector 14, 15.

The protector 33, 34 is formed generally as a cylinder that has an axial length direction along the inner surface 4a. The axial length is longer than the location of the inner race 24, 25 when the drive shaft 2 and the driven shaft 6 slide a maximum amount into the tubular intermediate shaft 4. The protector 33, 34 has an outer diameter that is smaller than inner diameter of the tubular intermediate shaft 4. The cylindrical clearance S is formed between the outer surface of the protector 33, 34 and the inner surface of the tubular intermediate shaft 4.

In this embodiment, when the drive shaft 2 and the driven shaft 6 slide a maximum amount and are moved off center axis further, a outer surface of the inner race 24, 25 and inner surface 33a, 34a of the protector 33, 34 provide interference to absorb a shock.

As a result, buckling of the tubular intermediate shaft 4 can be prevented, the inner race 24, 25 is prevented from directly contacting the inner surface of tubular intermediate shaft 4.

Specially, shock from the inner race 24, 25 to the protector 33, 34 is absorbed efficiently by clearance S. Therefore, the protector 33, 34 is prevented from buckling, and shock to the tubular intermediate shaft 4 is avoided.

Furthermore, the drive shaft 2 and the driven shaft 6 have different diameter portions, the diameter of first end portion 2a, 6a is larger than the diameter of second end portion 2b, 6b.

The shaft portion 7, 10 is formed with a staged diameter, instead of simply a small diameter portion. Thus, stiffness of shaft is increased.

Therefore, the natural frequency of transmission shaft is higher, and vibration and noise of the transmission caused by movement of the shaft is reduced. Vibration of the transmission shaft is generated between normal rotation speed and high rotation speed.

More specifically, a length of the tubular intermediate shaft 4 may be adjusted for application to varying vehicle sizes.

In addition, a diameter of the drive shaft 2 and the driven shaft 6 can be more greatly established in range smaller than inner diameter of tubular intermediate shaft. In this case, natural frequency of the transmission shaft can be increased.

The entire contents of Japanese Patent Application P2004-59974 filed Mar. 4, 2004 are incorporated hereby by reference.

1. A drive-transmission device comprising;
a drive shaft;
a driven shaft;
a tubular intermediate shaft;
a first joint;
a second joint;
the drive shaft is connected with a first end portion of the tubular intermediate shaft through the first joint;
the driven shaft is connected with a second end portion of the tubular intermediate shaft through the second joint; and
an absorbing mechanism for absorbing an axial load by permitting at least one of the drive and the driven shaft to slide into the tubular intermediate shaft through a respective joint.

2. A drive-transmission device comprising;
a drive shaft which has a first end portion and second end portion;
a driven shaft which has a first end portion and second end portion;
a tubular intermediate shaft which is disposed between the second end potion of the drive shaft and the second end portion of the driven shaft;
a first joint;
a second joint;
the first joint having a member defining a first outer race, a first inner race disposed inside of the first outer race, and a first ball connected with the first outer race and the first inner race for transmitting a torque between the first outer race and the first inner race;
the second joint having a member defining a second outer race, a second inner race disposed inside of the second outer race, and a second ball connected with the second outer race and the second inner race for transmitting a torque between the second outer race and the second inner race;
an absorbing mechanism for absorbing an axial load by permitting the drive and the driven shaft to slide into the tubular intermediate shaft when an axial load is applied;
wherein;
the first outer race is connected with a first end portion of the tubular intermediate shaft;
the second outer race is connected with a second end portion of the tubular intermediate shaft;
the first inner race is connected with a second end portion of the drive shaft;
the second inner race is connected with a second end portion of the driven shaft.

3. The drive-transmission device as claimed in claim 2,
wherein the diameter of the first end portion of the drive shaft is larger than a diameter of the second end portion of the drive shaft.

4. The drive-transmission device as claimed in claim 2,
wherein the diameter of the first end portion of the driven shaft is larger than the diameter of the second end portion of driven shaft.

5. The drive-transmission device as claimed in claim 3,
wherein the drive shaft has a conical portion between the diameter portions.

6. The drive-transmission device as claimed in claim 4,
wherein the driven shaft has a conical portion between the diameter portions.

7. The drive-transmission device as claimed in claim 2,
wherein the drive shaft and the driven shaft have different diameter portions, the diameter of the first end portion of each shaft being larger of than the diameter of the second end portion of each shaft.

8. The drive-transmission device as claimed in claim 7,
wherein each of the driven shaft and driven shaft has a conical portion between the diameter portions.

9. The drive-transmission device as claimed in claim 2, further comprising a connector;
wherein the first and second outer race is connected with the tubular intermediate shaft through the connector.

10. The drive-transmission device as claimed in claim 9,
wherein the connector defines a cylinder,
the cylinder having a different inner diameter portions,
the inner diameter of the tubular intermediate portion side being smaller than the inner diameter of the outer race side.

11. The drive-transmission device as claimed in claim 10,
wherein the connector has a conical portion between the different diameter portions.

12. The drive-transmission device as claimed in claim 9,
wherein the connector has a protector which extends along the tubular intermediate shaft.

13. The drive-transmission device as claimed in claim 12,
wherein the protector is integrated with the connector.

14. The drive-transmission device as claimed in claim 8, further comprising a connector;
wherein the first and second outer race is connected with the tubular intermediate shaft through the connector.

15. The drive-transmission device as claimed in claim 14,
wherein the connector has a protector which extends along the tubular intermediate shaft.

16. The drive-transmission device as claimed in claim 15,
wherein the protector is integrated with the connector.

17. The drive-transmission device as claimed in claim 14,
wherein the connector defines a cylinder,
wherein the cylinder having a different inner diameter portions,
the inner diameter of the tubular intermediate portion side is smaller than the inner diameter of the outer race side.

18. The drive-transmission device as claimed in claim 17,
wherein the connector has a conical portion between the difference diameter portions.

19. A drive-transmission device for a transmission shaft for vehicle comprising;
a drive shaft;
a driven shaft;
a tubular intermediate shaft;
a first joint;
a second joint;
the drive shaft is connected with a first end portion of the tubular intermediate shaft through the first joint;
the driven shaft is connected with a second end portion of the tubular intermediate shaft through the second joint; and
wherein an inner diameter of the tubular intermediate shaft is larger than a diameter of the drive shaft and driven shaft.
